(19) United States
(12) Patent Application Publication
(10) Pub. No.: US 2009/0274874 A1
(43) Pub. Date: Nov. 5, 2009

(54) Photonic Device And Method For Forming Nano-Structures

(76) Inventors: Zhiyong Li, Redwood City, CA (US); R. Stanley Williams, Portola Valley, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/247,832

(22) Filed: Oct. 8, 2008

Related U.S. Application Data
(60) Provisional application No. 61/049,211, filed on Apr. 30, 2008.

(51) Int. Cl. B32B 5/00; B28B 11/08

(52) U.S. Cl. 428/156; 428/221; 425/385; 264/293

(57) ABSTRACT

A photonic device includes a substrate and at least one molecularly assembled or atomic layer deposited nano-structure defined on the substrate. The nano-structure has a controlled resolution less than or equal to 100 nm.

### CROSS-REFERENCE TO RELATED APPLICATION

The present application claims priority from provisional application Ser. No. 61/049,211, filed Apr. 30, 2008, the contents of which are incorporated herein by reference in their entirety.

### BACKGROUND

The present disclosure relates generally to photonic devices and methods for forming nano-structures.

Nano-imprint lithography was initiated as a process to achieve nanoscale features (about 100 nm or smaller) with high throughput and relatively low cost in structures such as, for example, molecular electronic devices. During many imprinting processes, the nanoscale features are transferred from a mold to, for example, a polymer layer. As non-limiting examples, the mold may be used for a thermal imprint process, as well as for a UV-based imprint process.

In the thermal imprint process, to deform the shape of the polymer, the temperature of the film and mold is generally higher than the glass transition temperature of the polymer, so that the polymer flows more easily to conform to the shape of the mold. Hydrostatic pressure may be used to press the mold into the polymer film, thus forming a replica of the mold in the polymer layer. The press is then cooled below the glass transition temperature to “freeze” the polymer and form a more rigid copy of the features in the mold. The mold is then removed from the substrate.

In the alternate UV imprint process, a UV-curable monomer solution is used instead of a thermoplastic polymer. The monomer layer is formed between the mold and the substrate. When exposed to a UV light, the monomer layer is polymerized to form a film with the desired patterns thereon.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1 is a schematic flow diagram depicting an embodiment of the method for forming nano-structures;

FIGS. 2A through 2D are schematic and perspective views which together depict an embodiment of the method for forming nano-structures; and

FIGS. 2A through 2C, 2E and 2F are schematic and perspective views which together depict another embodiment of the method for forming nano-structures.

### DETAILED DESCRIPTION

Embodiments of the method disclosed herein advantageously enable control over the formation and resolution of nano-structures at or below 100 nm. Without being bound to any theory, it is believed that the removal of a polymeric resist from the process disclosed herein advantageously contributes to the ability to control the resolution on the sub-100 nm scale. The use of polymeric resists during nano-imprinting may deleteriously affect feature resolution at or below 100 nm (especially at or below 10 nm), in part, because of the proximity effect from the scattering of electrons or ions in the polymeric resist (e.g., during electron beam (e-beam) lithography). In some instances, the desirable critical dimension (e.g., at or below 10 nm or at or below 30 nm) of the nanostructure is comparable with the molecule size of the polymeric resist, as such, it may be difficult to achieve uniformity and resolution at the critical dimension. It is further believed that the mechanical strength of polymer resists prevents the formation of a nanoscale pattern with a desirable aspect ratio that is capable of surviving liftoff or etching processes. Still further, techniques such as e-beam lithography, UV lithography, or X-ray lithography may result in significant edge roughness on the patterned polymeric resist, which may be problematic when the patterned features are at or below 30 nm. The method(s) disclosed herein advantageously utilize guided molecular assembly or atomic layer deposition, both of which eliminate the use of polymeric resists and enhance feature precision control.

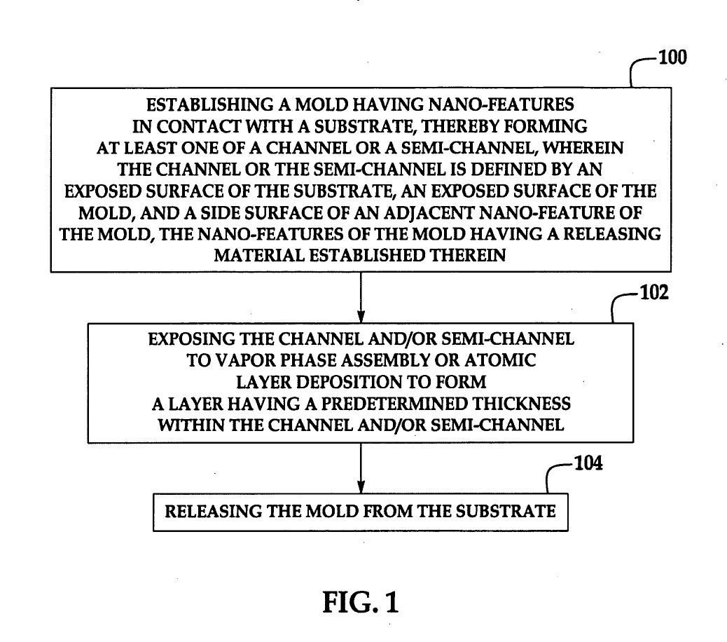

FIG. 1 depicts an embodiment of the method for forming nano-structures. Generally, the method includes establishing a mold having nano-features in contact with a substrate, thereby forming at least one of a channel or a semi-channel, wherein the channel and/or semi-channel is defined at least by an exposed surface of the substrate, an exposed surface of the mold, and a side surface of an adjacent nano-feature of the mold, the nano-features of the mold having a releasing material established thereon, as shown at reference numeral 100; exposing the channel and/or semi-channel to vapor phase assembly or atomic layer deposition to form a layer having a predetermined thickness within the channel, as shown at reference numeral 102; and releasing the mold from the substrate, as shown at reference numeral 104.

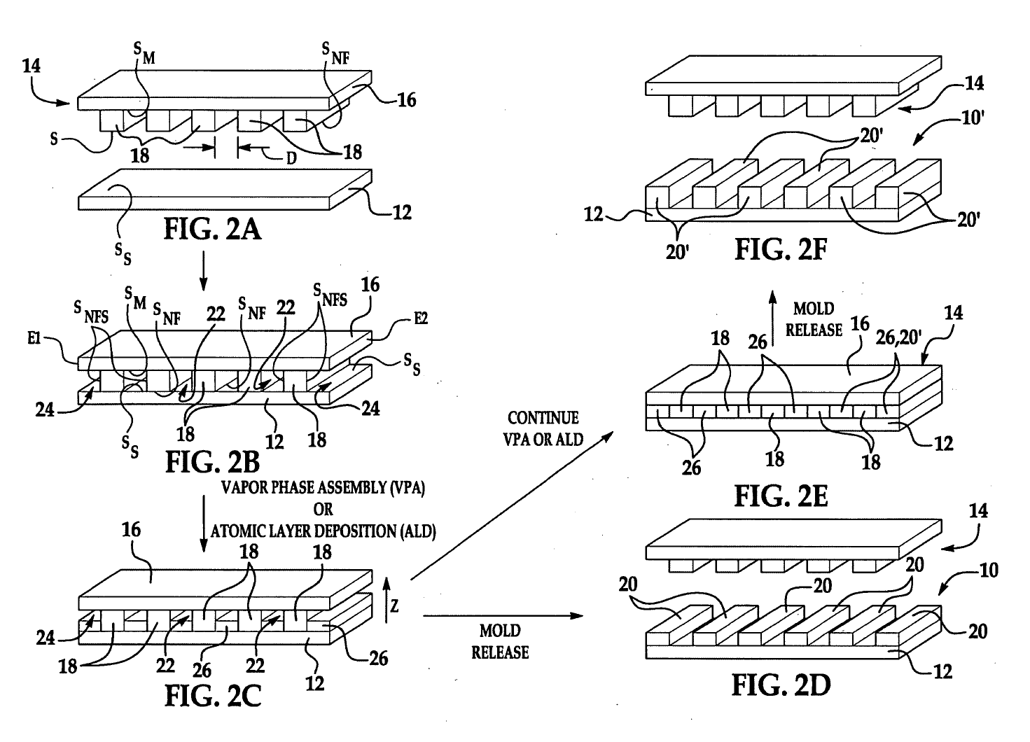

It is to be understood that the method shown in FIG. 1 is further described in reference to FIGS. 2A through 2F. More specifically, FIGS. 2A through 2D together depict one embodiment of the method for forming the nano-structures, and FIGS. 2A through 2C, 2E and 2F together depict another embodiment of the method for forming the nano-structures. As such, FIG. 2D depicts one embodiment of the resulting structure 10, and FIG. 2F depicts another embodiment of the resulting structure 10′. Such structures 10, 10′ may advantageously be used as or in photonic devices, nanoelectronic devices, nanoplasmonic devices, or enhanced Raman spectroscopy devices.

As shown in FIG. 2A, a substrate 12 and a mold 14 are utilized in the method(s) disclosed herein. It is to be understood that any suitable substrate 12 may be used. Non-limiting examples of suitable substrate materials include glass, quartz, silicon, fused silica, silicon carbide, silicon nitride, III-V materials, diamond, graphene, or combinations thereof. It is to be understood that the substrate 12 selected depends, at least in part, on the desirable end use of the structure 10, 10′.

The mold 14 may be pre-fabricated or may be formed as part of the method disclosed herein. The mold 14 generally includes a support 16 and a desirable number of nano-features 18 formed in or on the support 16. In an embodiment, the support 16 and nano-features 18 are formed of the same material, as the nano-features 18 are defined in a surface of the support 16. As a non-limiting example, the support 16 and nano-features 18 are formed of silicon oxide. In another embodiment, the nano-features 18 are established on the surface of the support 16, and thus may be formed of the same material as, or a different material than, the support 16. As a non-limiting example, the support 16 is formed of silicon or glass, and a diamond-like-carbon film is established on a surface thereof. The nano-features 18 may be defined in the diamond-like-carbon film.

The mold 14 (including the features 18) may be formed via e-beam lithography, focused ion beam lithography, diblock-copolymer self-assembly lithography, or other suitable methods. In one embodiment, the mold 14 is a superlattice structure formed of, for example, AlGaAs/GaAs, metal/metal oxide, or the like.

The nano-features 18 may have any desirable shape and/or configuration. Furthermore, any suitable number of nano-features 18 may be included in the mold 14 as long as adjacent distinct nano-features 18 are capable of defining a channel 22 (shown in FIG. 2B) when the mold 14 is placed in contact with the substrate 12. The nano-features 18 are generally measured on the nano-scale (i.e., have at least one dimension that is equal to or less than 100 nm) and are separated by a distance D less than or equal to 100 nm. In an embodiment, the distance D is less than or equal to 10 nm.

In an embodiment, a releasing material (not shown) is established on the surface of the mold 14, including on each surface of the nano-features 18. The releasing material may be any desirable material that enables the mold 14 to be released from the nano-structures 20, 20′ (20 shown in FIG. 2D, and 20′ shown in FIG. 2F) ultimately formed on the substrate 12. It is believed that the releasing material substantially prevents the material of the nano-structures 20, 20′ from sticking to the mold 14 upon release of the mold 14 from the substrate 12. Examples of suitable releasing materials include, but are not limited to molecular materials that self-assemble on the material selected for the nano-features 18. A non-limiting example of the self-assembling molecular material includes perfluorinated alkyl silane molecules. In one embodiment, the perfluorinated alkyl silane molecules are coated on silicon oxide nano-features 18. The releasing material may be deposited on the surface of the nano-features 18 via a vapor phase self-assembly process or a solution phase self-assembly process.

Referring now to FIG. 2B, embodiments of the method include establishing the mold 14 in contact with the substrate 12 such that a respective surface S_{NF} of the nano-features 18 contacts a surface S_{S} of the substrate 12. When such contact is made, respective channels 22 are formed between adjacent nano-features 18. The channels 22 are defined by the side surfaces S_{NFS} of the adjacent nano-features 18 and by the exposed mold 14 and substrate 12 surfaces S_{M}, S_{S} located between the adjacent nano-features 18. It is to be understood that when a nano-feature 18 is positioned closest to an end E1, E2 of the mold 14, semi-channels 24 may be defined by a side surface S_{NFS} of that nano-feature 18 and the respective adjacent exposed surfaces S_{M}, S_{S} of the mold 14 and substrate 12. The semi-channels 24 differ from the channels 22 in that they are defined by one less nano-feature side surface S_{NFS}. As shown in FIG. 2B, each of the channels 22 and semi-channels 24 includes an exposed surface S_{S} of the substrate 12.

Once the channels 22 and semi-channels 24 are formed, the stack (i.e., mold 14 and substrate 12) is then exposed to vapor phase assembly or atomic layer deposition. During such processes, molecules are self-assembled on the exposed substrate surface S_{S}, thereby forming layers 26 of the nano-structures 20, 20′ (see, respectively, FIGS. 2D and 2F) within the channels 22 and semi-channels 24, as depicted in FIG. 2C. The selected assembly process is performed under one or more predetermined conditions (e.g., pressure, number of cycles, assembly duration (time), temperature, or the like), which depend, at least in part, on the desirable thickness of the resulting nano-structures 20, 20′. As such, the process conditions may be altered in order to obtain a desirable nano-structure 20, 20′ thickness. In one embodiment, the assembly process may be performed such that the channels/semi-channels 22, 24 are partially filled (as shown in FIG. 2C). It is to be understood that in these embodiments, any desirable portion of the channels/semi-channels 22, 24 may be filled that is less than the total volume of each of the channels/semi-channels 22, 24. In another embodiment, the assembly process may be continued until the channels/semi-channels 22, 24 are completely filled, as shown in FIG. 2E. It is believed that both vapor phase assembly and atomic layer deposition enable atomic or sub-nanometer (i.e., less than 100 nm) precision control over the growth of the layers 26, and thus over the thickness of the resulting nano-structures 20, 20′. As such, nano-structures 20, 20′ having a thickness equal to or less than 100 nm may be controllably formed using the method(s) disclosed herein.

The materials that are vapor phase assembled or atomic layer deposited in the channels/semi-channels 22, 24 include any material that is compatible with the selected process and is suitable for the nano-structures 20, 20′. The two processes are compatible with a number of materials, including, but not limited to metals, metal oxides, silicon oxide, self-assembling organic molecules (e.g., trimethylaluminum, methylsilane, and cyclopentadienyl(trimethyl)platinum(IV)), or the like.

Once the layers 26 are grown to a desirable thickness, the mold 14 is removed, and the resulting nano-structures 20, 20′ are exposed. Mold release is accomplished by physically removing the mold 14 from contact with the substrate 12 and formed nano-structures 20, 20′. It is to be understood that the previously described releasing layer (not shown) facilitates ease of mold 14 removal from the substrate 12 and formed nano-structures 20, 20′. The releasing layer generally does not stick to the surface of the mold 14 upon removal, thereby substantially ensuring mold 14 reusability.

The structures 10, 10′ including nano-structures 20, 20′ formed via the methods disclosed herein are shown in FIGS. 2D and 2F. Nano-structures 20 that partially filled the channels/semi-channels 22, 24 are shown in FIG. 2D, and nano-structures 20′ that completely filled the channels/semi-channels 22, 24 are shown in FIG. 2F. It is believed that the releasing layer enables growth to preferentially initiate from the substrate surface S_{S} in the Z direction (shown in FIG. 2C), and that such conditions contribute to the nano-structures 20, 20′ having minimal edge roughness. Structures 10, 10′ with minimal edge roughness may be particularly suitable for use as or in photonic devices, such as, for example, thin oxide photonic grating structures. It is believed that the reduced and/or eliminated edge roughness of the nano-structures 20, 20′ reduces the potential for optical loss in such devices.

While several embodiments have been described in detail, it will be apparent to those skilled in the art that the disclosed embodiments may be modified. Therefore, the foregoing description is to be considered exemplary rather than limiting.

What is claimed is:

1. A photonic device, comprising:
a substrate; and
at least one molecularly assembled or atomic layer deposited nano-structure having a controlled resolution less than or equal to 100 nm defined on the substrate.

2. The photonic device as defined in claim 1, further comprising a mold releasably contacting the substrate, the mold including:
a support;
at least two distinct nano-features formed in or on a surface of the support; and
a releasing material established on the nano-features;
wherein the at least two distinct nano-features of the support and the substrate define a channel therebetween, the channel defining an area in which the at least one molecularly assembled or atomic layer deposited nano-structure is formed.

3. The photonic device as defined in claim 2 wherein the releasing material is a self-assembling molecular material selected from perfluorinated alkyl silane molecules.

4. The photonic device as defined in claim 1 wherein the at least one nano-structure has a controlled resolution less than or equal to 10 nm.

5. The photonic device as defined in claim 1 wherein the at least one molecularly assembled or atomic layer deposited nano-structure is free of a polymer resist.

6. A mold for use in a nanoimprint process, comprising:
a support;
at least one nano-feature defined on a surface of the support; and
a releasing material established on the at least one nano-feature, the releasing material configured to substantially prevent the at least one nano-feature from sticking to a substrate in contact with the mold during the nanoimprint process.

7. The mold as defined in claim 6 wherein the releasing material is selected from perfluorinated alkyl silane molecules.

8. A method for forming nano-structures, comprising:
establishing a mold having nano-features in contact with a substrate, thereby forming at least one of a channel or a semi-channel, wherein the channel or the semi-channel is defined at least by an exposed surface of the substrate, an exposed surface of the mold, and a side surface of an adjacent nano-feature of the mold, the nano-features of the mold having a releasing material established thereon;
exposing the at least one of the channel or the semi-channel to vapor phase assembly or atomic layer deposition to form a layer having a predetermined thickness within the at least one of the channel or the semi-channel; and
releasing the mold from the substrate.

9. The method as defined in claim 8 wherein prior to establishing, the method further comprises pretreating the mold to establish the releasing material on the nano-features.

10. The method as defined in claim 9 wherein pretreating is accomplished by depositing perfluorinated alkyl silane molecules on the nano-features of the mold via vapor phase assembly or atomic layer deposition.

11. The method as defined in claim 8 wherein exposing is accomplished such that the layer partially or completely fills the at least one of the channel or the semi-channel.

12. The method as defined in claim 8 wherein the nano-structures are formed having a controlled resolution less than or equal to about 100 nm.

13. The method as defined in claim 8 wherein the releasing material is configured to substantially prevent the nano-structures from sticking to the mold when the mold is released from the substrate.

14. The method as defined in claim 8 wherein the channel is defined by the exposed surface of the substrate, the exposed surface of the mold, and respective side surfaces two adjacent nano-features.

15. The method as defined in claim 8 wherein the semi-channel is defined by the exposed surface of the substrate, the exposed surface of the mold, and a side surface of one adjacent nano-feature.
